(19) United States
(12) Patent Application Publication
(10) Pub. No.: US 2016/0238503 A1
(43) Pub. Date: Aug. 18, 2016

(54) DEVICE, SYSTEM AND METHOD FOR DENSITY MEASUREMENTS USING GAMMA RADIATION

(71) Applicant: DEAD SEA WORKS LTD., Beer Sheva (IL)

(72) Inventors: Itzhak ORION, Beersheba (IL); Mordechay AHARONI, Lehavim (IL)

(21) Appl. No.: 15/030,027

(22) PCT Filed: Oct. 12, 2014
(86) PCT No.: PCT/IL2014/050897

§ 371 Date: Apr. 15, 2016

Related U.S. Application Data
(60) Provisional application No. 61/890,909, filed on Oct. 15, 2013.

(51) Int. Cl. G01N 9/24; G01V 5/00

(52) U.S. Cl. CPC G01N 9/24; G01V 5/00

(57) ABSTRACT

There is provided a system for the measurement of density of a raw material comprising at least one penetrating device, wherein said device includes at least one radiation source; at least one detector; at least one input device; and at least one output device.

### FIELD OF THE INVENTION

The present invention relates to processes for density measurements of raw materials, specifically, materials located under sea water or under other layer(s) of liquid(s).

### BACKGROUND OF THE INVENTION

The mass density or density of a material is its mass per unit volume. Usually represented by the Greek letter ρ, density is defined as mass divided by volume:

$$ρ = \frac{m}{V} ,$$

where ρ is the density, m is the mass, and V is the volume. In some cases, density is also defined as its weight per unit volume. The term density is equally applicable to solids (including suspensions), liquids, and gases, whereas usually values of density are given in terms of grams per cubic centimeter.

If the average density (including any air below the waterline) of an object is less than water it will float in water and if it is more than water it will sink in water.

Density is sometimes expressed by the dimensionless quantity “specific gravity” or “relative density”, i.e. the ratio of the density of the material to that of a standard material, usually water. Thus a specific gravity less than one means that the substance floats in water.

A densitometer may be used to indicate and record the density of a flowing stream of a liquid or a gas.

Two precision methods, the oscillator or vibrator method and the magnetic method, have emerged which allow more rapid and accurate determinations on liquid systems.

In the oscillator method, the density of a sample is related to the change in resonance frequency of a laterally vibrating tube. This frequency is inversely proportional to the square root of the mass of the tube and its contents. By calibrating the tube with media of known density at a given temperature, the density of unknown solutions may be determined if the volumes are strictly identical. It is now established, that the accuracy of this method decreases as the viscosity of the medium increases. Hence, accurate viscosity measurements must accompany the density calibrations for a given instrument.

The density of a material varies with temperature and pressure. This variation is typically small for solids, suspensions and liquids but much greater for gases.

### SUMMARY OF THE INVENTION

According to some demonstrative embodiments, there is provided a system for the measurement of density of a raw material including at least one penetrating device, wherein the device may include at least one radiation source; at least one detector; at least one input device; and at least one output device.

According to some embodiments, the raw material may be Carnallite.

According to some embodiments, the at least one radiation source may include a Gamma radiation source.

According to some embodiments, the Gamma radiation source may be Co-60.

According to some embodiments, the at least one detector may include a scintillator.

According to some embodiments, the scintillator may be made of inorganic crystal.

According to some embodiments, the at least one detector may be contained in a Teflon container.

According to some embodiments, the at least one penetrating device may include a tube wherein the at least one radiation source can be positioned at a first, inactive, position and at a second, active position.

According to some embodiments, the at least one penetrating device may include an opening at a predetermined angle, configured to enable the at least one radiation source to omit radiation towards the at least one detector.

According to some embodiments, the angle may be between 0-90 degrees, preferably between 20-50 degrees, most preferably, 45 degrees.

According to some demonstrative embodiments, there is provided a method for in situ measuring of the density of a raw material including inserting at least one penetrating device into the raw material, wherein said device includes at least one radiation source; positioning at least one detector at a predetermined angle from said penetrating device, wherein said detector is adapted to receive radiation omitted from said radiation source and wherein said detector is adapted to transmit information to at least one input device; and gathering information from said input device and providing density measurement results of said raw material via at least one output device.

According to some embodiments, transmitting information to at least one input device may include a wireless transmission.

According to some embodiments, positioning said at least one detector at a predetermined angle from said penetrating device may include placing said detector on the surface of the raw material.

According to some embodiments, the in situ measuring may be performed in a hazardous environment.

According to some embodiments, the hazardous environment may include liquid environments selected from the group including liquid environments rich in salt, acidic environments, high temperature environments or combinations thereof.
According to some demonstrative embodiments, there is provided a penetrating device for the measurement of a density of a raw material, comprising: a hollow tube configured to encompass a radiation source; a lead covering, surrounding said tube; and a cylindrical housing configured to encompass said tube and said lead covering, wherein said device is configured to be inserted to said raw material and omit radiation.
According to some embodiments, the radiation source can be positioned at a first, inactive, position within said tube and at a second, active position within said tube.
According to some embodiments, when the source is at the second, active position within said tube, radiation omitted from said source can be detected by at least one detector.

### BRIEF DESCRIPTION OF THE DRAWINGS

The present invention will become fully understood from the detailed description given herein below and the accompanying drawings, which are given by way of illustration and example only, and thus not limiting in any way, wherein:

FIG. 1 is a schematic illustration of a system in accordance with some demonstrative embodiments described herein.

FIG. 2, is a schematic illustration of a system in accordance with some demonstrative embodiments described herein.

FIG. 3A is a schematic illustration of a penetrating device, and in FIG. 3B is a schematic illustration of the angle of radiation transmission from a penetrating device to a detector in accordance with some demonstrative embodiments described herein.

FIG. 4 is a schematic illustration of an angle of radiation from a radiation source to a detector, in accordance with some demonstrative embodiments described herein.

FIG. 5 depicts a graph illustrating the use of a LaBr₃(Ce) detector with Co-60 radiation source inside Carnallite, in accordance with some demonstrative embodiments described herein.

FIG. 6 is a schematic illustration of a statistical analysis of the density measurement results as measured by a radiation sampler and a manual cylindrical sampler.

FIG. 7 depicts a calibration graph in accordance with some demonstrative embodiments described herein.

### DETAILED DESCRIPTION OF THE INVENTION

In some demonstrative embodiments, there is provided a device, system and method for the in situ density measurement of raw materials using a source of radiation.

According to some demonstrative embodiments, the system of the present invention may be preferably used to determine the density measurement of a material located under at least one liquid layer, e.g., under sea water.

According to some embodiments, the system may include at least one radiation source, preferably emitting Gamma radiation, and at least one sensor, to determine the density of a raw material.

According to some demonstrative embodiments, the system described herein may be mounted on a vessel, e.g., a boat, and deployed to determine the in situ density of a material located below water level.

According to some demonstrative embodiments, the system described herein may be used to determine the in situ density of a material located in a hazardous environment. According to some embodiments, the term “hazardous environment” as used herein, may refer to any environment which may be hazardous to a human and/or a machine e.g., including electronic components, including, for example, liquid environments rich in salt, acidic environments, high temperature environments and the like.

According to some demonstrative embodiments, the present invention provides for a system for the in situ density measurements of materials. According to these embodiments, the in situ measurements are highly preferable, in comparison to manual extraction of a material and laboratory density measurements, whereas in situ measurements do not disturb the natural environment of the examined material, e.g., in manual measurements disturbing the natural environment of the examined sampler may cause the density results to be inaccurate.

According to some demonstrative embodiments, the system described herein may include at least one penetrating device which includes a radiation source, e.g., configured to penetrate a raw material for which the density is to be measured; at least one detector, e.g., configured to detect the radiation emitted from the radiation source; at least one data processing device (also referred to as “input device”), e.g., configured to receive input from the at least one detector; and at least one output device, e.g., configured to provide an output representing the density measured by the system.

According to some demonstrative embodiments, the at least one data processing device a computer, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a video device, an audio device, an audio-video (A/V) device, DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), cellular radio-telephone communication systems, a cellular telephone, a wireless telephone, a Personal Communication Systems (PCS) device, multi-standard radio devices or systems, a wired or wireless handheld device (e.g., BlackBerry, Palm Treo), a Wireless Application Protocol (WAP) device, a Geographic Pointing System (GPS) or the like.

According to some demonstrative embodiments, the at least one output device may include, for example, a monitor, a screen, a flat panel display, a Cathode Ray Tube (CRT) display, a Liquid Crystal Display (LCD), an LED display, a plasma display unit, a printer, one or more audio speakers or earphones, or other suitable output devices.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

According to some preferred embodiments, the system of the present invention may be used to measure and determine the in-situ density of salt and/or other suitable sediment.

According to some preferred embodiments, the system of the present invention may be used to measure and determine the density of Carnallite, which is an evaporite mineral, a hydrated potassium magnesium chloride with formula: KClMgCl₂.6(H₂O).

Carnallite usually forms in marine evaporite deposits where sea water has been concentrated and exposed to prolonged evaporation. Carnallite is usually massive to fibrous with rare pseudohexagonal orthorhombic crystals.

Being is an important source of Potassium Chloride (also referred to herein as “KCl” or “Potash”), which is an invaluable source for the production of synthetic fertilizers, measuring the density of Carnallite in aqueous ponds, where it precipitates, usually includes sampling the Carnallite and measuring the density in a lab.

In contrast, the present invention allows for the in situ measurement of Carnallite density.

According to some embodiments, the system described herein may include a device which emits radiation. The device may be configured to penetrate a material, e.g., a material for which the density id to be measured.

According to some embodiments, the device is configured to contain one or more radiation emitting sources.

According to some demonstrative embodiments, the term “radiation” may include any suitable energy that comes from a source and travels through some material or through space. Examples of radiation may include electromagnetic, e.g., Gamma radiation or X-ray radiation, particulate radiation, Co-60 radiation, Cs-137 radiation, Na-22 radiation, Na-24 radiation, Au-198 radiation, Zn-65 radiation, Mn-54 radiation, Uₙₐₜ radiation, Thₙₐₜ radiation, Radium radiation, annihilation sources radiation and the like.

Gamma rays typically have frequencies above 10 exahertz (or >1019 Hz), and therefore have energies above 100 keV and wavelengths less than 10 picometers.

According to some demonstrative embodiments, the preferred source for Gamma rays for the present invention may be Cobalt-60, (also referred to herein as “Co-60”). Co-60 is a synthetic radioactive isotope of cobalt with a half-life of 5.27 years. It may be produced artificially by neutron activation of the isotope Co-59. Co-60 decays by beta decay to the stable isotope nickel-60 (⁶⁰Ni), wherein the activated nickel nucleus emits two gamma rays.

In some demonstrative embodiments, the one or more radiation emitting sources (also referred to herein as “the radiation source”) and as described in detail below with respect to the drawings, may be contained within the device in a housing, e.g., a cylinder shape housing, for example, enabling the radiation source to move within the housing. As described in detail below, the moving of the radiation source within the housing may enable the concealment of the radiation source, e.g., when the device is not used.

According to some embodiments, the radiation source may be at least partially exposed when the device is used, in order to enable the measurement of a the density of a material.

According to some demonstrative embodiments, the radiation source may be mounted inside a lead shielding container (“lead cylinder”) that has a conical opening in a defined angle, e.g, having the angle aimed toward a detector located above the container.

According to some demonstrative embodiments, the angle may be at a range between 0-90 degrees. Preferably, the angle is between 20-50 degrees, most preferably 45 degrees or optionally 26.56 degrees.

As previously described, the lead cylinder may include a vertical hole, wherein the radiation source may be placed at two stages: at the center of the lead cylinder, e.g., during storage, and down, i.e., at the end of the lead cylinder, for example, during irradiation.

In some demonstrative embodiments, Co-60 may be the preferred radiation source due its dual energy emission lines at the energies: 1173, 1332 keV. The gamma rays can penetrate into a dense solid layer of several decimeters of a chosen material, e.g., Caranllite. The attenuation of the radiation intensity is dependent on the specific attenuation coefficient (for certain energy), on the layer thickness, and on the layer density (gram/cc). As mentioned hereinabove, the Co-60 has a half-life of 5.272 years, therefore the decay has to be taken into account in order to compare different measurements at different periods of time.

According to some demonstrative embodiments, the system may include a detector, configured to detect the gamma radiation emitted from the radiation source.

According to some demonstrative embodiments, the detector may include any device capable of recovering information contained in photon radiation, including, LaBr₃(Ce) (also known as “BrilLianCE™”) or for example, NaI (Tl), CsI, CsI(Tl), CsI(Na), Li(Eu), BGO, CdWO₄, ZnS(Ag), LuAP, GSO, YAP, YAG, LSO, CdZnTe. According to some embodiments, the preferred detector may be LaBr₃(Ce), as this detector has optimal spectral resolution for detection of radiation at high levels of background radiation.

According to some preferred embodiments of the present invention, the detector may be scintillator. For example, a preferred detector may capable of converting the kinetic energy of charged particles to a visible light with substantial scintillation capabilities, for example, as taught by Glenn F. Knoll, “Radiation Detection and Measurement” 3^{rd} ed. John Wiley & Sons, 1999, in Chapter 8.

According to some demonstrative embodiments, the stages of detecting radiation by the scintillator detector may include:
Radiation energy absorption: molecule excitation
Luminescence: visible light emission
Light transport to the photo-cathode
Light absorption and electron emission in the cathode
Multiplying electrons bunches by the Photomultiplier
Electronic signals output to the multi-channel-analyzer
Spectrum display and processing

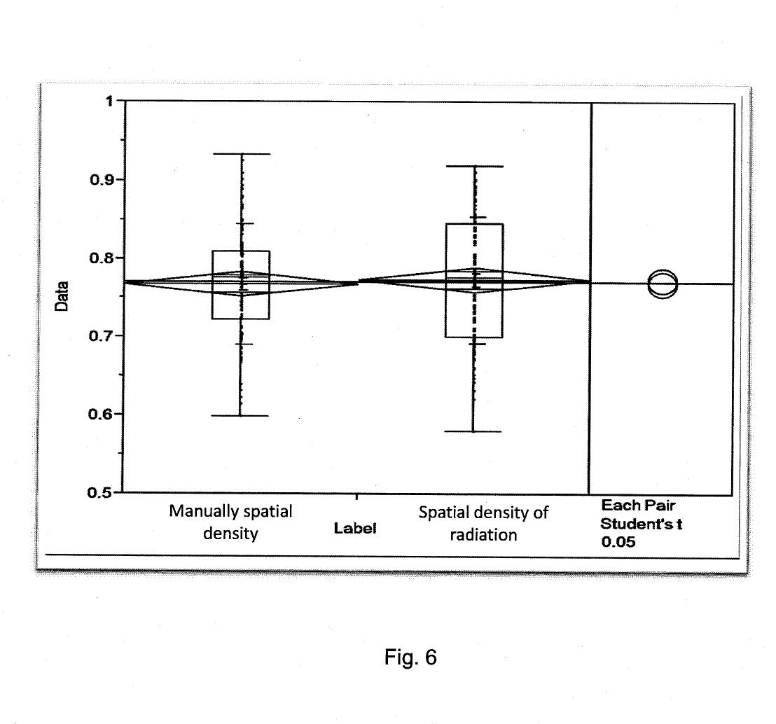

The extent and ability of radiation detection of the detector according to some embodiments is further detailed below with respect to FIG. 6.

According to some demonstrative embodiments, the detector may be placed in a designated housing, for example, to prevent the penetration of liquid, e.g., water, to the detector. According to some embodiments, the housing may be extremely important when the detector is placed in a hazardous environment,

According to some preferred embodiments, the housing may be made of a material capable of blocking and/or preventing the hazardous environment from damaging the detector, including, for example, from Polytetrafluoroethylene (PTFE) (Teflon® by DuPont Co.) and/or silicone and the like.

According to some demonstrative embodiments, the detector may include one or more wireless device(s), e.g., configured to communicate with the at least one input device. The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

According to some embodiments, the system may preferably include a detector having one or more wireless device(s), e.g., due to the corrosive nature of hazardous environments which can harm communication cables and/or cords.

According to some embodiments, the radiation emitted from the source is preferably detected beyond and/or through an inspected material in order to implement an attenuation measurement method.

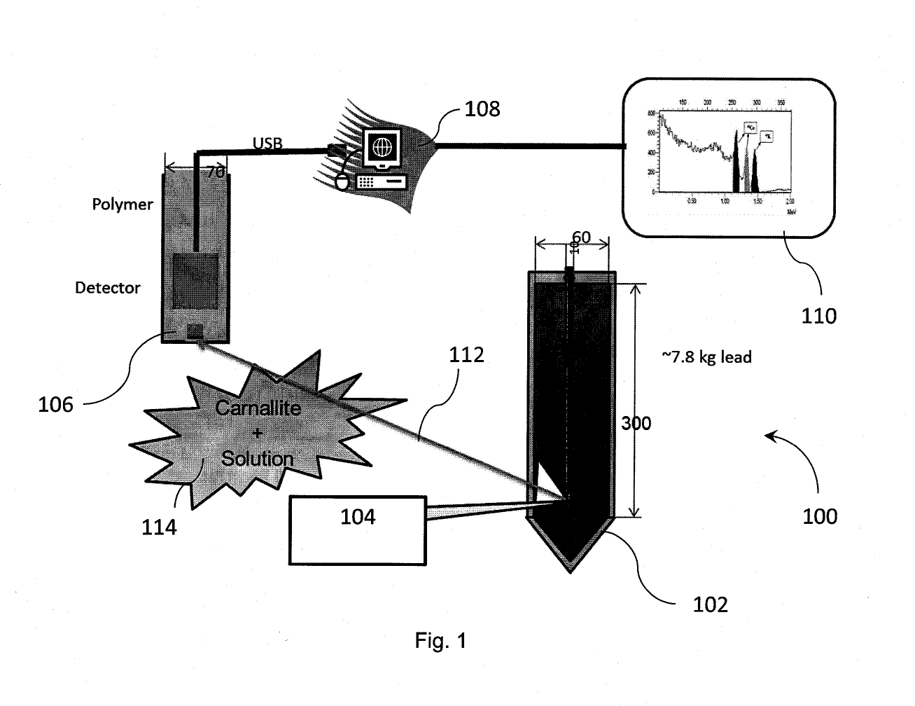

Reference is now made to FIG. 1 which illustrates a system 100 in accordance with some demonstrative embodiments described herein.

As shown in FIG. 1, system 100 includes a penetrating device 102, a detector 106, an input device 108 and an output device 110.

According to some demonstrative embodiments, penetrating device 102 includes a radiation source 104, e.g., configured to radiate towards detector 106.

According to some embodiments, device 102 is configured to penetrate into a raw material, for example, material 114, which may include Carnallite and water as shown in FIG. 1.

Detector 106 is configured to be positioned on top of material 114, e.g., not penetration into material 114.

According to some embodiments, and as shown in FIG. 1 source 104 may radiate abeam of radiation 112 towards detector 106, for example, wherein the radiation passes through material 114 before it reaches detector 106.

According to some embodiments, detector 106 is configured to transmit data to input device 108, for example, data related to the amount of radiation received at detector 106 after passing through material 114.

According to some embodiments, input device 108 may process the data received from detector 106 and calculate the density of material 114. Input device 108 may transfer the calculated data to present a calibration graph and/or table on output device 110.

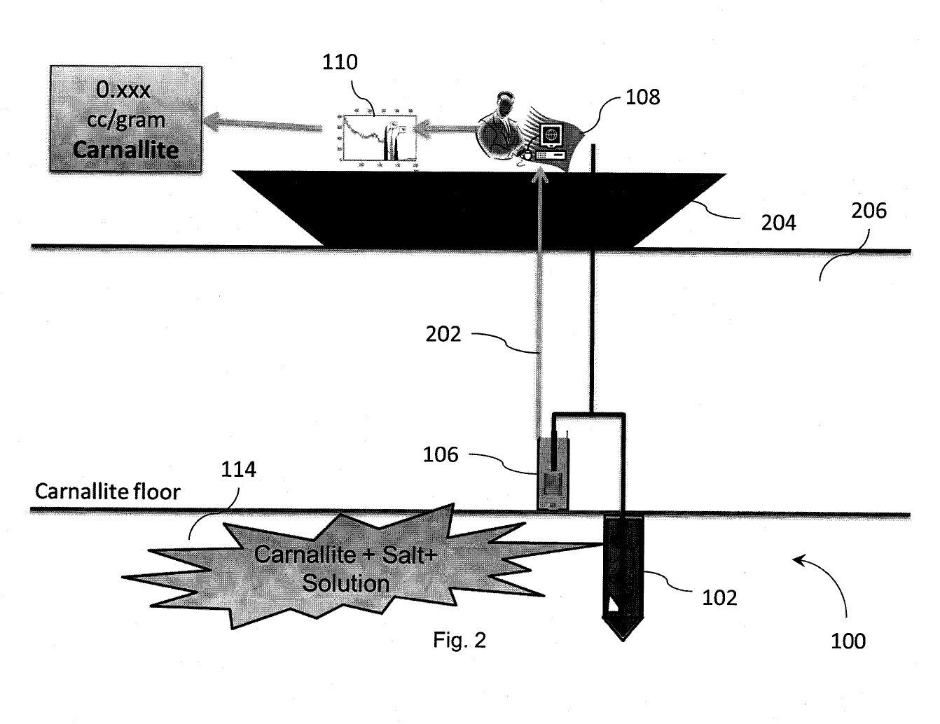

Reference is now made to FIG. 2, which illustrates a system 100 in accordance with some demonstrative embodiments.

According to some embodiments, as shown in FIG. 2, system 100 may be mounted on a watercraft 204, e.g., a boat.

Watercraft 204 may float on water layer 206, e.g., a sea, wherein material 114 is located below layer 206.

System 100 may be used to measure and determine the density of material 114, wherein device 102 and detector 106 are lowered into water layer 206. According to some embodiments, device 102 penetrates material 114, e.g., a Carnallite floor, and detector 106 is placed on top of material 114.

In some embodiments, device 102, having been placed within material 114 radiates towards detector 106. Detector 106 sends data 202 to input device 108. According to some embodiments, data 202 may be send to device 108 via a cable, e.g., a USB cord, or via a wireless route.

According to some embodiments, input device 108 may process the data received from detector 106 and calculate the density of material 114. Input device 108 may transfer the calculated data to present a calibration graph and/or table on output device 110, e.g., and determining the result density of material 114.

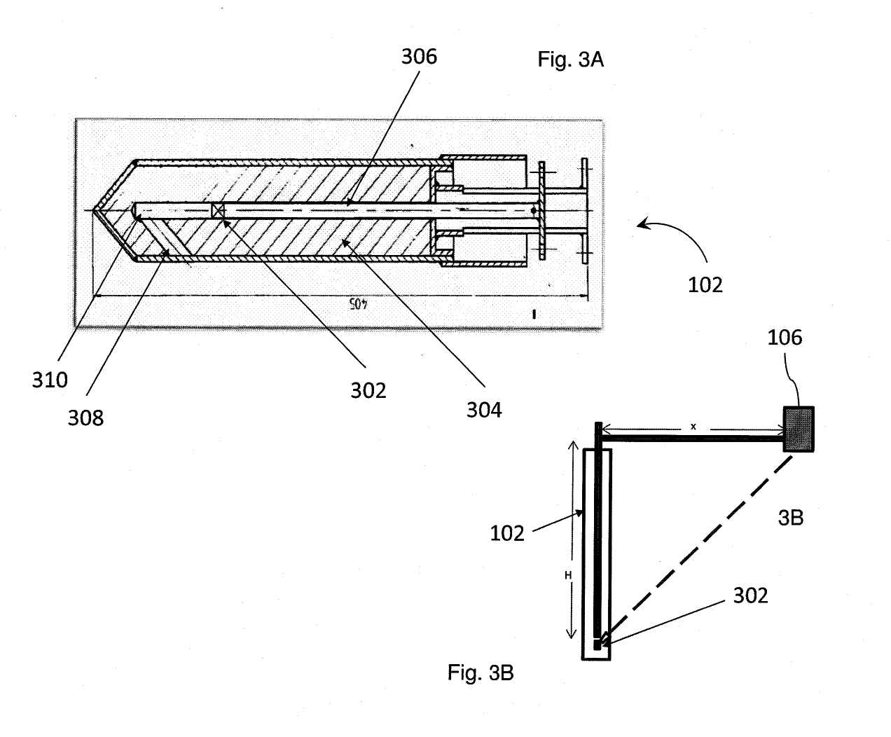

Reference is now made to FIG. 3, which illustrates in FIG. 3A a schematic illustration of penetrating device 102, and in FIG. 3B a schematic illustration of the angle of radiation transmission from penetrating device 102 to detector 106.

According to some embodiments, as shown in FIG. 3B, device 102 may include a hollow cylinder 306 to contain a radiation source 302.

According to some embodiments, device 102 may include lead (Pb) coating 304, surrounding cylinder 306.

According to some embodiments, device 102 may operate in a first and a second operating modes. According to some embodiments, the in the first operating mode, radiation source 302 may be positioned essentially in the center of cylinder 306. According to these embodiments, device 102 is not active, and a user of device 102 is relatively protected from potentially harmful radiation from source 302 since source 302 is contained within cylinder 306 and surrounded by Pb.

According to other embodiments, device 102 may operate at a second operating mode, wherein radiation source 302 may be positioned at a position 310, e.g., at the end of cylinder 306.

According to some embodiments, coating 304 may have one or more openings 308, to enable the exposure of the radiation from radiation source 302.

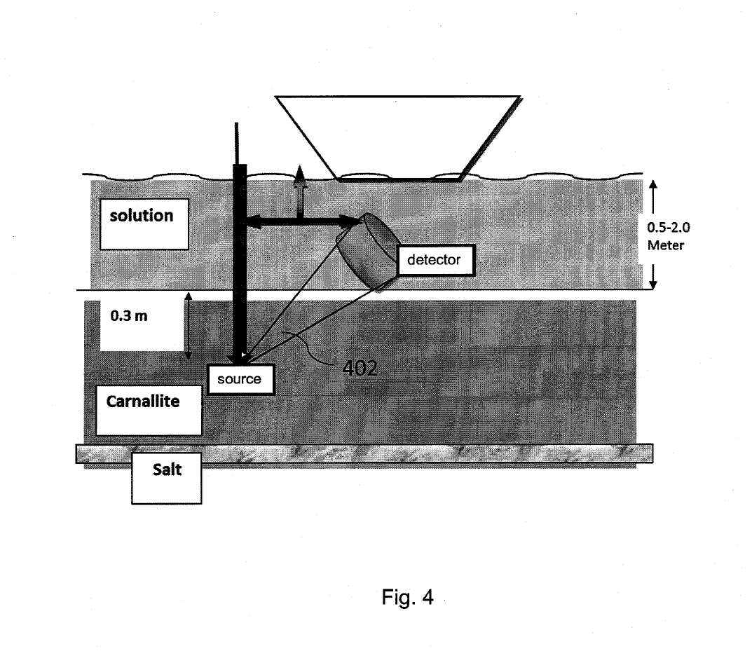

According to some embodiments, opening 308 may be at a predetermined angle (as explained for example, with relation to FIG. 3B and FIG. 4), for example, aimed toward a detector, e.g., detector 106 (FIG. 1). According to some embodiments opening 308 may be sealed, e.g., to prevent penetration of liquid into device 102. According to some embodiments, opening 308 may be sealed using any suitable material including, plastics, carbohydrate complex materials and the like.

According to some embodiments, when device 102 is operating in the second operating mode, source 302 is positioned at position 310, e.g., radiating radiation.

According to some demonstrative embodiments, as shown in FIG. 3B, when device 102 is operating in the second operating mode, i.e., when source 302 is positioned at position 310, source 302 may radiate towards detector 106.

In some embodiments, device 102 is penetrating into a layer, e.g, an examined layer for which the density is to be measured, to the depth (H). According to some embodiments, detector 106 is positioned on the layer, e.g., on the surface of the examined layer, at a horizontal distance (x).

Detector 106 is positioned at a specific distance (x), to enable the effective receipt of outgoing radiation from source 302, passing through the examined layer. According to some embodiments, opening 308, may be at a gazing angle tangent, e.g., determined in light of depth (H) and detector 106 position—the ratio H/x.

According to some demonstrative embodiments, the angle may be at a range between 0-90 degrees. Preferably, the angle is between 20-50 degrees, most preferably 45 degrees, e.g., when the ration H/x is 1/1. The angle may optionally be 26.56 degrees when the ratio H/x is 2/1.

According to some embodiments, when the material examined is shallow, e.g., when the examined layer is thin, the angle may be 63 degrees, e.g., when the ration H/x is 1/2. Reference is now made to FIG. 4, which is a schematic illustration of an angle 402 of radiation from a radiation source to a detector, according to some demonstrative embodiments.

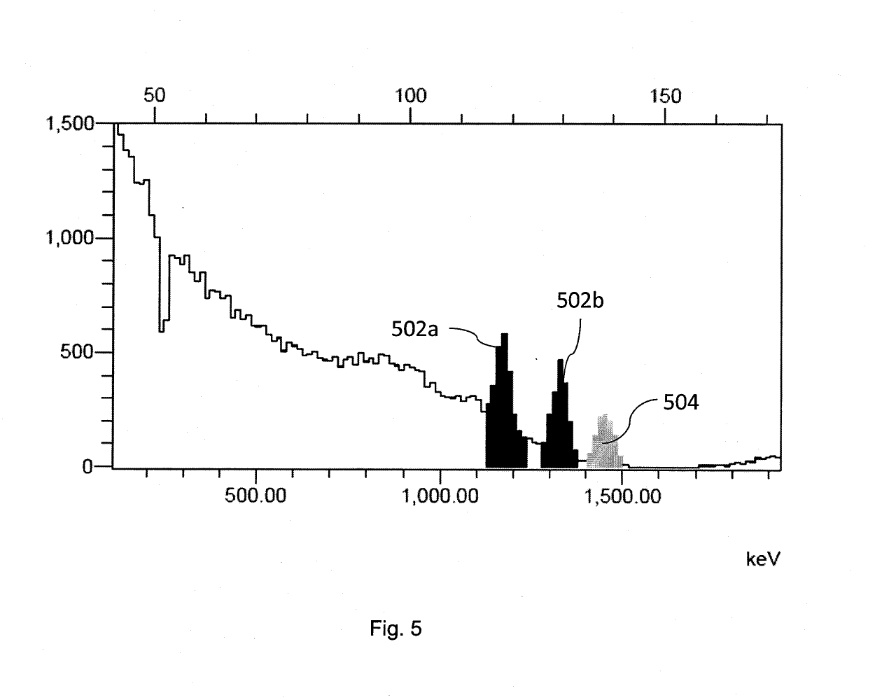

Reference is now made to FIG. 5, which illustrates a graph depicting the use of a LaBr₃(Ce) detector with Co-60 radiation source inside Carnallite. Axis X depicts the Gamma radiation energy, whereas Axis Y depicts the counts accumulated during a time period of ten minutes. As shown in the graph, peaks 502a and 502b correspond to the Co-60 source and peak 504 corresponds to the existing K-40, e.g., from the environment.

Reference is now made to Table 1, listing the results of a sampling using a manual cylindrical sampler (e.g., a sampler by Eijkelkamp®) and a radiation sampler. The statistical analysis of the density measurement are shown in FIG. 6. according to some demonstrative embodiments described herein.

TABLE 1

| | No. of | Average Density | |
|---|---|---|---|
| Sampling method | samples | (gr/cm³) | Variance |
| Manual cylindrical sampler | 100 | 0.768 | 0.077 |
| Radiation Sampler | 100 | 0.773 | 0.081 |

As shown in FIG. 6, the results of the radiation sampler are statistically equivalent to those of the manual cylindrical sampler. The results are in good agreement with respect to the average density measured, and exhibit a relatively small variance. It is to be noted that the variance between the samplers can be reduced via longer measurements and/or higher source activity.

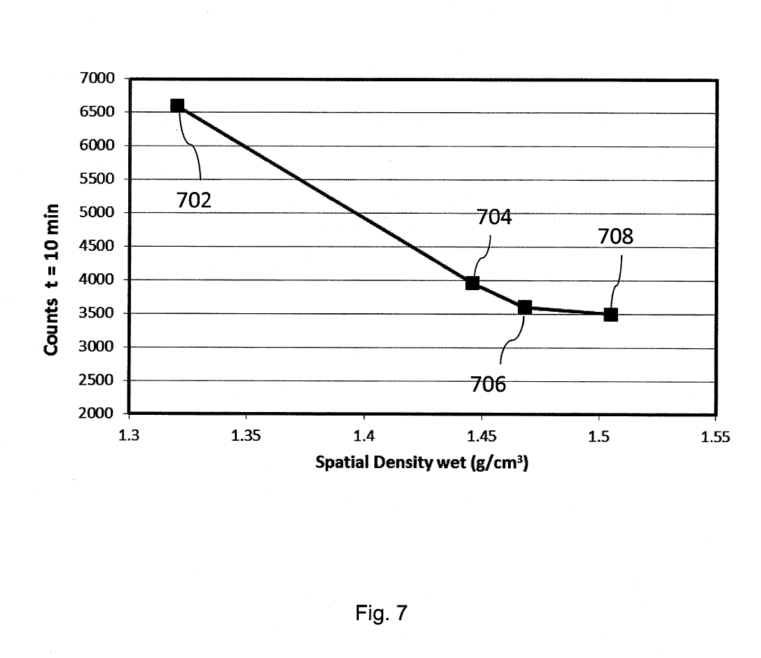

Reference is now made to FIG. 7, which illustrates a calibration graph in accordance with some demonstrative embodiments.

The main purpose of the calibration graph in accordance with some demonstrative embodiments described herein is to convert and/or quantify, i.e., to provide visual graphical representation, the response of the radiation detector to the bulk density for an examined layer placed in between a radiation source and the detector

According to some embodiments, one of the purposes of the graph is to assist in obtaining a calibration equation, wherein the variable of the equation is the peak net counts (in 10 min) as read by the detector. The calibration equation enables to calculate the density of the examined material, e.g., Carnallite density.

In the laboratory we prepared.

The graph shown in FIG. 7 demonstrates the counts from a detector versus the spatial density of a bulk in g/cm3 as measured in an experiment conducted in a laboratory. In the experiment several mixtures of carnallite grain types were prepared and some pound solution was poured onto the grains until saturation has occurred to provide different materials for examination.

This procedure was repeated several times, wherein in each case a different liquid-to-dry ratio was set

As shown in FIG. 7, point 702 was obtained in a pound solution, and points 704, 706 and 708 are from different carnallite grain types. The calibration line enables finding the density at each measuring point from the detector's reading after using a “daily correction factor”.

At the start of every new pound measurements, there is an initial 10 min solution reading, in order to obtain the “daily correction factor”. The “daily correction factor” takes into consideration the specific pound conditions (solution density, temperature), and the current source activity to consider the source half-life. The ratio of this solution reading to the one on the graph is defined as the “daily correction factor”.

It is possible to convert reading to spatial density by the graph by fitting, or/and setting point on the line, or/and by interpolation/extrapolation.

Analysis of the Example:

The spatial density of the carnallite in the bulk (called also “dry density”) is calculated using the following equation developed by K. Preiss (K. Preiss “Carnallite Density Measurements in the Dead-Sea Pounds”, Negev Institute For Arid Zone Research, October 1971 (In Hebrew)):

d_{bulk}=dₛ(d−dₗ)/(d_{z}−dₗ)

Where:

d—the measured medium density (“wet density)

dₗ—the solution density

dₛ=1.6742 g/cm³ the specific density of pure solid carnallite.

From the system measurements, it is possible to obtain the bulk carnallite density.

While this invention has been described in terms of some specific examples, many modifications and variations are possible. It is therefore understood that within the scope of the appended claims, the invention may be realized otherwise than as specifically described.

1. A system for the in-situ measurement of density of a raw material comprising:
at least one penetrating device, wherein said device includes at least one radiation source;
at least one detector;
at least one input device; and
at least one output device.

2. The system according to claim 1, wherein said raw material is Carnallite.

3. The system according to claim 1, wherein said at least one radiation source includes a Gamma radiation source.

4. The system according to claim 3, wherein said Gamma radiation source is Co-60.

5. The system according to claim 1, wherein said at least one detector includes a scintillator.

6. The system according to claim 5, wherein said scintillator is made of inorganic crystal.

7. The system according to claim 1, wherein said at least one detector is contained in a Teflon container.

8. The system according to claim 1, wherein said at least one penetrating device includes a tube wherein said at least one radiation source can be positioned at a first, inactive, position and at a second, active position.

9. The system according to claim 8, wherein said at least one penetrating device includes an opening at a predetermined angle, configured to enable said at least one radiation source to omit radiation towards said at least one detector.

10. The system according to claim 9, wherein said angle is between 0-90 degrees.

11. The system according to claim 10, wherein said angle is between 20-50 degrees

12. The system according to claim 11, wherein said angle is 45 degrees.

13. A method for in situ measuring of the density of a raw material comprising:
inserting at least one penetrating device into the raw material, wherein said device includes at least one radiation source;
positioning at least one detector at a predetermined angle from said penetrating device, wherein said detector is adapted to receive radiation omitted from said radiation source and wherein said detector is adapted to transmit information to at least one input device; and
gathering information from said input device and providing density measurement results of said raw material via at least one output device.

14. The method of claim 13, wherein said raw material is Carnallite.

15. The method of claim 13, wherein said at least one radiation source includes a Co-60 Gamma radiation source.

16. The method of claim 13, wherein said transmitting information to at least one input device includes a wireless transmission.

17. The method of claim 13, wherein positioning said at least one detector at a predetermined angle from said penetrating device includes placing said detector on the surface of the raw material.

18. The method of claim 13, wherein said in situ measuring is to be performed in a hazardous environment.

19. The method of claim 18, wherein said hazardous environment includes liquid environments selected from the group including liquid environments rich in salt, acidic environments, high temperature environments or combinations thereof.

20. A penetrating device for the measurement of a density of a raw material, comprising:
a hollow tube configured to encompass a radiation source;
a lead covering, surrounding said tube; and
a cylindrical housing configured to encompass said tube and said lead covering,
wherein said device is configured to be inserted to said raw material and omit radiation.

21. The device of claim 20, wherein said radiation source can be positioned at a first, inactive, position within said tube and at a second, active position within said tube.

22. The device of claim 21, wherein when said source is at a second, active position within said tube, radiation omitted from said source is detected by at least one detector.
